(19) United States
(12) Patent Application Publication
(10) Pub. No.: US 2008/0210860 A1
(43) Pub. Date: Sep. 4, 2008

(54) Segmented ion trap mass spectrometry

(76) Inventor: Viatcheslav V. Kovtoun, Santa Clara, CA (US)

Correspondence Address: THERMO FINNIGAN LLC, 355 RIVER OAKS PARKWAY, SAN JOSE, CA, 95134, US

(21) Appl. No.: 11/713,263

(22) Filed: Mar. 2, 2007

(51) Int. Cl. H01J 49/26

(52) U.S. Cl. 250/283; 250/281

(57) ABSTRACT

An ion trap is provided with at least two discrete trapping regions or segments. Both segments are located in a vacuum chamber of a mass spectrometer system. An entrance of the ion trap is disposed downstream to a laser based ionization source to receive the ions with a wide range of kinetic energies that have been generated by the laser-based ionization source. Once sufficient ions have been accumulated in the first segment and sufficient time has passed to cool the ions, they are transferred to the second segment and ultimately ejected through an aperture or slot to a detector arrangement to produce a mass spectrum.

### FIELD OF THE INVENTION

This invention relates particularly to mass analyzers that utilize laser-based ionization sources.

### BACKGROUND OF THE INVENTION

In recent years, matrix assisted laser desorption ionization (MALDI) mass spectrometry, a technique that provides minimal fragmentation and high sensitivity for the analysis of a wide variety of fragile and non-volatile compounds, has become widely used. In its simplest form, the MALDI technique involves depositing the sample (analyte) and a matrix dissolved in a solvent as a spot on a target plane. After the solvent has evaporated, the mixture of sample and matrix is left on the sample plate. This is inserted into a mass spectrometer where a pulse from a laser irradiates the matrix and causes it to evaporate. The sample is carried with the matrix, ionized, and analyzed by the mass spectrometer. MALDI sources are typically used with spectrometers that allow for storage of ions, such as ion trap mass spectrometers and fourier transform mass spectrometers, for example, or time-of-flight (TOF) mass spectrometers. These configurations can be used to determine molecular weights of biomolecules and their fragment ions, monitor bioreactions, detect post-translational modifications, and perform protein and oligonucleotide sequencing, for tissue imaging and many more applications.

The MALDI ionization process inherently produces ions with a wide range of kinetic energy due to the energy from the laser being dissipated primarily in the matrix, and resulting in ions being formed in different points in time and space within the ion source. This causes ions with the same mass to obtain different kinetic energies and velocities during their extraction out of the ion source.

Typically, when combined with a mass analyzer such as a TOF or an ion trap mass analyzer, the ions produced by the MALDI ionization process have such a wide range of kinetic energies, some of which are relatively high in value, that it is difficult to trap the ions in the mass analyzer. The ions with high kinetic energy values in particular tend to escape from the interior of the ion trap. Therefore, before the ions are trapped, they are typically cooled so that the kinetic energy variation is reduced. Cooling generally requires interaction with other molecules and the use of higher pressure (than the mass analyzer) intermediate configurations which may influence fragmentation behavior. To enable optimization of both ion trapping, and facilitate the use of ion sources of various natures, intermediate component(s) are used in conjunction with the use of the mass analyzer. Over the years the laser-based ionization sources have essentially become decoupled from the mass analyzers, with various interface configurations being used between the two.

When a Fourier Transform Mass Spectrometer (FTMS) or an ion trap type mass spectrometer is utilized with ions produced via the MALDI process, the wide range of kinetic energy in the ions reduces the efficiency by which ions travel into and become trapped in FT and ion trap type mass spectrometers, consequently resulting in decreased sensitivity. To compensate for this, ion guides are typically positioned in sequential vacuum pumping stages between the MALDI source and the mass spectrometer, each pumping stage having a pressure to enable multiple ion collisions to occur with neutral background particles, and cooling to occur. In essence, the MALDI ionization source is decoupled from the subsequent mass analyzer, enabling independent optimization of each major component of the configuration. Each pumping stage has cost associated with it, and brings with it its own set of considerations and issues.

When a TOF mass spectrometer is utilized with ions produced via the MALDI process, since the ions have a wide kinetic energy variation, ions of equal mass and charge may not necessarily arrive at the detector at exactly the same time. The result is that the ion signal at the detector has a broad peak, and consequently the mass resolution, which is a measure of an instruments capability to produce separate signals (isotopic peaks) from ions of similar mass, is limited. To compensate for this limitation, configurations have been proposed which minimize the effects of the ions' wide kinetic energy range, such as pulsed ion extraction and ion mirrors or reflectrons. The ion mirrors or reflectrons have costs associated with them, and once again bring with them their own set of considerations and issues.

An overall configuration of a typical MALDI mass spectrometry system 100 is illustrated schematically in FIG. 1. As shown, the MALDI mass spectrometry system 100 includes a laser 110 positioned to direct a beam of radiation 125 onto a sample spot 120 deposited on a sample plate 125. The beam of radiation 125 rapidly heats a thin layer of matrix on the sample plate 125 and produces an eruption of matrix from the illuminated portion of the sample plate 125. Matrix plume contains analyte ions and other particles including matrix vapors, small crystals and ions of matrix. Ions produced via absorption of the laser beam energy at the sample spot 120 are transferred by ion optics 130 such as a quadrupole ion guide through one or more orifice plates or skimmers 135 into a mass analyzer device 140, which is located in a high-vacuum chamber 145, may take the form, for example, of a TOF analyzer, quadrupole analyzer, ion trap, or FT/ICR analyzer. Typically, ions will pass through one or more chambers of successively lower pressures separated by orifice plates or skimmers, the chambers being differentially pumped to reduce total pumping requirements. For the purpose of clarity, chamber walls, intermediate ion optics, and pumps have been omitted from the drawings. The operation of the various components of mass spectrometer 100 is directed by a control and processing system 150, which will typically consist of a combination of general-purpose and specialized processors, application-specific circuitry, and software and firmware instructions. The control and processing system also provides data acquisition and post-acquisition data processing services. Control and processing system 150 may alternatively take the form of an ASIC or other special purpose processor.

Various interface configurations have evolved enable the laser-based ion source and the mass analyzer to be optimized in terms of their individual operation and performance. However, the existence of the additional interface components add an additional layer of complexity to the overall mass spectrometry system, additional physical components and an additional expense. The additional interface components also require additional resources be applied to overcome issues and inefficiencies in terms of ion transference between the ion source and the mass analyzer.

Whilst the foregoing apparatus may offer various solutions and benefits, there remains a need in the laser-based mass spectrometry art for more alternative configurations of laser-based mass spectrometers.

### SUMMARY

Roughly described, a mass spectrometer for laser-based ion sources according to an embodiment of the present invention includes an ion trap having at least two distinct trapping regions or segments. One of the broader forms of the invention involves an apparatus for performing mass spectrometry analysis, in particular mass spectrometry for laser-based ion sources, wherein the ions generated by the ion source have a wide range of kinetic energies. Both segments are located in a vacuum chamber of a mass spectrometer system. An entrance of the ion trap is disposed downstream to a laser based ionization source to receive the ions with a wide range of kinetic energies that have been generated by the laser-based ionization source. Once sufficient ions have been accumulated in the first segment and sufficient time has passed to cool the ions, they are transferred to the second segment and ultimately ejected through an aperture or slot to a detector arrangement to produce a mass spectrum.

In broad terms, a mass analyzer of the current invention allows for ion traps to be used of a lower pressure than can typically be utilized without the use of intermediate configurations between the ion source and the mass analyzer.

In one broad form of the invention, the ion trap effectively partitions the ion capture function to a first segment of the ion trap, and the analytical scan function to the second segment of an ion trap, thereby facilitating good collisional energy removal and consequent capture efficiency without compromising analytical scan resolution or speed.

In yet another broad form of the invention, the ion trap having at least two distinct trapping regions is utilized to provide for mass-to-charge ratio separation prior to analysis.

In yet a further broad form of the invention, once sufficient ions have been accumulated in the first segment and sufficient time has passed to cool the ions, they are transferred to the second segment for manipulation prior to ultimately ejecting the manipulated ions through an aperture or slot to a subsequent segment or subsequent mass analyzer to produce a mass spectrum.

Particular implementations of the invention can include one or more of the following features. Improved mass resolution and improved isolation efficiencies can be attained without the use of intermediate configurations between the ion source and the ion trap.

### BRIEF DESCRIPTION OF THE DRAWINGS

For a better understanding of the nature and objects of the invention, reference should be made to the following detailed description, taken in conjunction with the accompanying drawings, in which:

FIG. 1 is a symbolic diagram of a conventional MALDI mass spectrometer.

FIG. 2 is a symbolic diagram of a mass spectrometer system which includes an ion trap with two distinct trapping regions or segments according to an embodiment of the present invention.

FIG. 3 is a flowchart depicting the steps of a first method for operating the ion trap of FIG. 2.

FIG. 4 is a symbolic diagram depicting the components of a mass spectrometer system according to another embodiment of the present invention.

FIG. 5 is a flowchart depicting the steps of a second method for operating the ion trap of FIG. 2, whereby ions are isolated and fragmented in the second segment of the ion trap.

FIG. 6 is a flowchart depicting the steps of a method for operating the ion trap of FIG. 2 for mass-to-charge ratio separation prior to analysis.

FIG. 7 is a symbolic diagram depicting the components of a mass spectrometer system according to a further embodiment of the present invention.

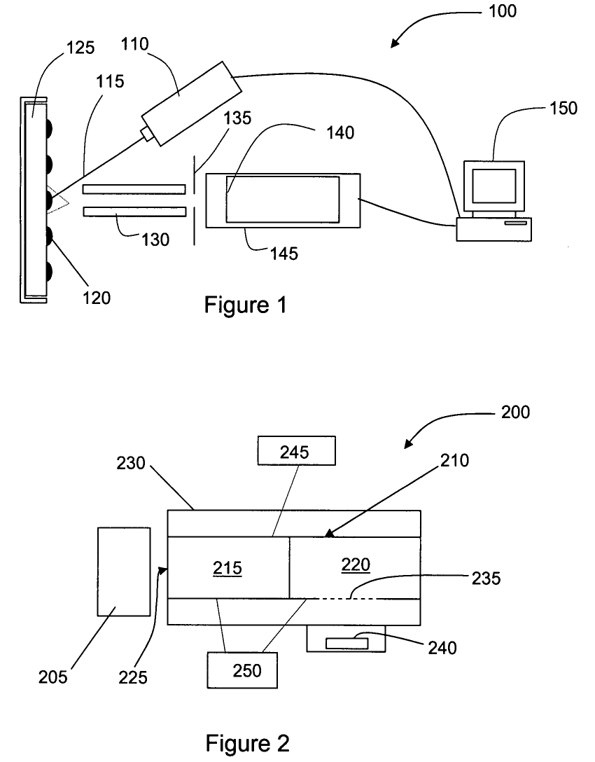

Like reference numerals refer to corresponding parts throughout the several views of the drawings.

### DETAILED DESCRIPTION OF EMBODIMENTS

FIG. 2 is a schematic depiction of the major components of a mass spectrometer system 200 comprising a laser-based ionization source 205 and an ion trap 210 in accordance with an embodiment of the present invention. The ion trap configuration 210 of the present invention is configurable to provide a plurality of (at least two) substantially discrete trapping volumes or segments 215, 220, each of these segments or combination of segments being electrically isolated from one another when an electrical and/or magnetic isolation mechanism is activated, and capable of acting in combination as a continuous device when the segments are “assembled” or the electrical/magnetic isolation means has been deactivated. The ion trap configuration must enable the interior volume of the ion trap 210 to be physically subdivided such that ions may be spatially trapped in one or more of the discrete trapping regions 215, 220 of the ion trap 210.

The multi-segment configuration of the ion trap 210 offers substantial advantages over the prior art in terms of its ability to capture and trap fragile ions without causing unintended fragmentation. Ions arriving at the entrance 225 of the ion trap 210 will typically have a kinetic energy spread that exceeds the amount of kinetic energy that can be collisionally removed during one pass through the length of a conventional two-dimensional ion trap when the ion trap is operated with normal buffer gas pressures. This results in a portion of the injected ions coming back out of the interior of a conventional ion trap, thereby reducing injection efficiency and decreasing the number of ions available for mass analysis. Injection efficiency may be improved in a conventional ion trap by increasing the buffer gas pressure, but, operation at higher buffer gas pressure has an adverse effect on analytical scan and isolation resolutions. Injection efficiency may also be improved by accelerating the injected ions so that more energy is lost per collision. However, accelerating the ions to higher kinetic energies also produces more undesired fragmentation of fragile ions. The design of ion trap 210, which partitions the ion capture function to a first segment 215 of an ion trap and the analytical scan function to a second segment 220 of an ion trap, facilitates good collisional energy removal and consequent capture efficiency without compromising analytical scan resolution and/or speed. It does so by enabling the ions to gradually lose their kinetic energy in the first segment 215 of the ion trap 210, the ions lose kinetic energy via gas collisions with increased time of confinement in the first segment 215 of the ion trap 210 before being transferred to the second analysis segment 220 of the ion trap 210. By the time the ions have been transferred to the second segment 220, they typically move in a well-confined group, hence improving resolution of the analysis results. This novel configuration enables ion traps to of lower pressures to be utilized than in conventional systems in which the laser-based ionization source is connected directly to the conventional ion trap.

In FIG. 2, these discrete trapping regions are depicted as the first and second segments, 215 and 220 respectively. Both segments 215, 220 are located in a vacuum chamber 230 of the mass spectrometer system 200. An entrance 225 of the ion trap 210 is disposed downstream to the laser based ionization source 205 to receive the ions that have been generated by the laser-based ionization source 205 with a wide range of kinetic energies. The second segment 220 is configured to receive and confine ions transferred from the first segment 215 and to ultimately eject the ions through an aperture or slot 235 to a detector arrangement 240 to produce a mass spectrum. In broad terms, the first segment 215 of the ion trap 210 is used to trap, store, cool and/or isolate ions, but not for mass analysis. The second segment 220 is used to trap, isolate and/or mass analze, but not necessarily cool ions.

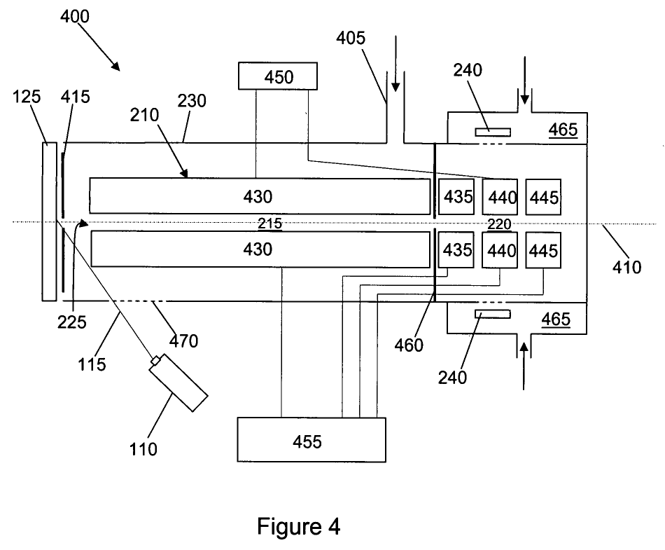

The first segment 215 is adjacent and in communication with the second segment 220, both segments typically having a common coaxial axis such that an ion path can be defined going from the first segment 215 into the second segment 220. It is noted that the term “adjacent”, as used herein to describe the relative positioning of the first segment 215 and the second segment 220, is intended to denote that the first segment 215 and the second segment 220 are positioned in proximity, but does not exclude the placement of one or more ion optic elements or one of more additional segments between the two segments of the trap, in fact, the embodiment described later with respect to FIG. 4 requires an ion optic element.

In general, an RF generator 245 applies the same RF voltage from an RF generator to both segments 215 and 220 of the ion trap 210 to generate an RF multipole potential to confine ions radially in the trapping volume about the longitudinal axis of the linear ion trap 210. The RF voltages may alternatively be derived from discrete RF generators, one for each segment of the ion trap 210. A DC supply 250 applies separate discrete DC voltages to the segments (215 and 220) of the ion trap 210 to trap ions in any of or combination of the segments axially along the trapping volume of the ion trap 210. The separate voltages can be generated by separate DC power supplies for each segment, or by one power supply and the appropriated electronics to supply each segment with its own discrete voltage. Each segment may also supplied with its own supplemental excitation voltage. Once the ions have been trapped in any one of or combination of segments of the ion trap, the application/modification of RF, DC and/or supplemental voltage components can be used to influence the trapped ions to distribute themselves along the length of the ion trap in a predetermined manner, to influence ions to move from one segment to another within the ion trap, to vacate a segment of predetermined ions, isolate predetermined ions in a segment, or minimize coupling of ions between adjacent segments.

A portion of the second segment 220 of the ion trap 210 is provided with a slot or aperture 235 to enable ions to pass to the detector arrangement 240.

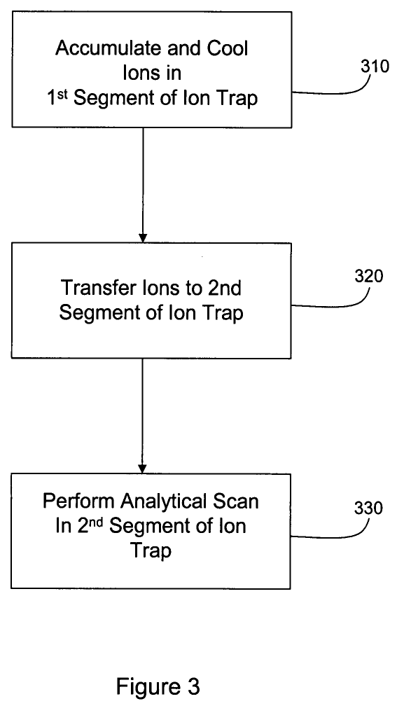

FIG. 3 illustrates a method of operating the ion trap configured according to an aspect of the invention. In operation, the laser-based ionization source 205 generates ions from an analyte material, for example the eluant from a liquid chromatograph (not depicted). The generated ions enter the entrance 225 of the ion trap 210 directly, (rather than travel through several intermediate chambers of successively lower pressure such as ion optics 130, in the prior art systems to the vacuum chamber 145 that accommodates the mass analyzer 140). Ions are accumulated and trapped in step 310 in the first segment 215 of the ion trap 210 based on a desired criteria, the criteria being for example, mass-to-charge ratio, mass-to-charge ratio range, time, intensity threshold, number of pulses, etc. The first segment 215 of the ion trap 210 not only serves to accumulate ions but also to provide collisional cooling. Once the desired criteria determining the accumulated ion population has been reached, the ion population remains in the first segment 215 until sufficient time has elapsed for the kinetic energy variation of the ions to be reduced. Alternatively, the first segment 215 has a length associated with it such that by the time the ions have traveled the length of the first segment 215, the kinetic energy variation will have been reduced. At that time, the ions are transferred in step 320 from the first segment 215 of the ion trap 210 to the second segment 220 of the ion trap 210, where they are once again trapped. The trapped ions are eventually subjected to an analytical scan, which typically requires that the ions be passed onto a detector arrangement 240 in step 330, the detector arrangement 240 providing a signal indicative of the ion population. Optionally, the ions in the first segment 215 and/or the second segment 220 of the ion trap 210 may be manipulated in so desired, before they are extracted and passed to the detector arrangement 240.

A more detailed embodiment of the present invention is depicted in FIG. 4. As shown, the MALDI mass spectrometry system 400 includes a laser 110 positioned to direct a beam of radiation 115 through a window 470 disposed in the chamber 230 and onto a sample spot deposited on a sample plate 125. Ions from the MALDI ion source (consisting of the laser 110, beam of radiation 115 and a sample spot deposited on the sample plate 125), once generated pass directly into a vacuum chamber 230. The ions then enter the entrance 225 of an ion trap 210. Alternatively, the entrance 225 of the ion trap 210 is disposed at one end of the vacuum chamber 230, such that the ions enter the ion trap 210 as they enter the vacuum chamber 230. Typically, vacuum chamber 230 is maintained at a pressure in the order of less than 50 mtorr, for example 40 mtorr, 30 mtorr, 20 mtorr, 10 mtorr, 1 mtorr of 0.5 mtorr, by the use of a pump associated with pumping port 405. In an alternative embodiment, an ion optic element 415 may be disposed between the sample plate 125 and the entrance 225 of the ion trap 210 to control the transfer of ions, and influence the ions to propagate in the desired fashion.

The ion trap 210 may take the form of a segmented two-dimensional quadrupole ion trap mass analyzer. Two-dimensional quadrupole ion traps (also referred to as linear ion traps) are well known in the mass spectrometry field. Generally described, a two-dimensional quadrupole ion trap may be constructed from four rod electrodes disposed about the trap interior. The rod electrodes are arranged into two pairs, each pair being opposed across the central longitudinal axis of the trap. In order to closely approximate a pure quadrupole field when the RF voltages are applied, each rod is formed with a truncated hyperbolic surface facing the trap interior. In other implementations, round (circular) or even planar (flat) electrodes can be substituted for the hyperbolic electrodes in order to reduce manufacturing complexity and cost, though such devices generally provide more limited performance. Generally described, ions are radially confined to the trap interior by application of a radio-frequency (RF) trapping voltage in a prescribed phase relationship. Axial confinement of the ions may be effected by application of a suitable direct current (DC) offset to end sections of the rod electrodes and/or electrodes located longitudinally outward of the rod electrodes.

The ion trap 210 in this particular embodiment is configured to define at least two segments or trapping volumes 215 and 220 about an axis 410 of the ion trap 210. Both segments 215, 220 of the ion trap 210 are in the vacuum chamber 230, and hence both segments 215, 220 have pressures that are similar to one another. There may however be an inherent differential caused by the positioning of the pumping port 405 governed by the laws of physics. The multipole rod assembly illustrated is a sectioned multirod assembly, each rod divided longitudinally into 4 sections 430, 435, 440 and 445. The gap between adjacent sections typically being small enough that from at least the ions' point of view, the rods are continuous, and the fields generated do not depart significantly from those produced by continuous rods. In this particular configuration illustrated, the first section 430 of the rods defines the first segment 215, and the remaining three sections 435, 440 and 435 of the rods define the second segment 220. Each of the sets of rods, the x-set and the y-set are supplied with an RF voltage from an RF generator 450, and each of the sections one through four can be supplied with a different DC voltage via DC supply 455. In this manner, the voltage along the longitudinal axis 410 of the ion trap 210 can be adjusted and trapping regions formed to isolate ions in segments 215 and 220 if so desired, or in the interior volumes formed via sections 430 and 440. In an alternative configuration each of, or combinations of, the sections one through four can also be supplied with different RF voltages.

In yet another alternative to the configuration described above, the third section 445 of the three sectioned second segment 220 can be substituted with a plate. The number of sections can be further reduced by utilizing an apertured plate to provide the barrier at the entrance end of the second trapping region, thus substituting for the first section 435 of the second segment 220.

Another manner in which the trapped volumes can be created is by utilization of a single sectioned or continuous rod configuration (not illustrated). The segments or trapping volumes may be formed by creating potential barriers which spacially divide the ion trap, for example, by placing rings (not illustrated) around the multipole rod assembly, coaxial to and at various locations along the axis 410. These rings may comprise a combination of non-conductive material (so as not to adversely affect the performance of the quadrupole rods) and conductive material (around the circumference of the rods). A potential can be applied to the conductive material such that a radial electric field is generated, which in combination with the quadrupolar field creates an electrical barrier and hence creates segments or trapping volumes within the interior volume of formed by the four rods, and along the axis 410 of the multipole rod assembly.

In either case described above, the first segment 215 of the multirod assembly provides an environment and/or conditions which allows the ions trapped in this segment cool sufficiently before entering the second segment 220 of the multirod assembly and operation of the second segment 220 can be optimized. Such an environment may be provided by the first segment 215 being of a length such that ions traveling along it have sufficient time to cool, and such conditions may be that the ions are trapped in the first segment for a time sufficient for them to cool down to an appropriate energy level. Once cooled, the ions are allowed to enter the second segment 220, where they are subsequently trapped. The mass spectrum of the trapped ions may be acquired by mass-sequentially ejecting the ions from the interior volume of the second section 440 of the second segment 220 of the ion trap 210 to an associated detector arrangement 240, either in a radial direction orthogonal to the central longitudinal axis of the ion trap, as described in U.S. Pat. No. 5,420,425 to Bier et al., or in an axial direction parallel to the central longitudinal axis, as described in U.S. Pat. No. 6,177,668 to Hager. In such a configuration, the detector(s) are located axially outward of the linear ion trap, rather than radially outward of the ion trap as in the illustrated embodiment. The detector arrangement 240 is disposed in a chamber 465 which is at a pressure that is lower than that of the ion trap 210 itself, typically in the range of 10⁻⁴ torr to 10⁻⁶ torr, for example 0.5 mtorr. In this manner, the pressures are separately optimized for the functions of cooling in the first segment 215 of the ion trap 210, and detection in a chamber 465 adjacent to the second segment 220 of the ion trap 210.

It will be understood that certain features and configurations of the mass spectrometer systems 200 and 400, for example the laser-based ionization sources 205 and 110 and the detector system 240 are presented by way of illustrative examples, and should not be construed as limiting the apparatus to a specific configuration. For example, the laser-based ionization source 205 or 110 may be a conventional laser-based source, such as a matrix assisted laser desorption/ionization (MALDI) source, laser desorption ionization (MALDI) source, laser desorption ionization (LDI) source, laser desorption/ionization on silicon (DIOS) source, or surface enhanced laser desorption ionization (SELDI) sources, for example. The laser-based ionization source 205 may also include continuous ion sources used as laser-based sources.

The detector arrangement 240 may take numerous forms. Ion detection systems generally comprise an ion converting element (for example a conversion dynode) followed by an electron multiplying element (such as a continuous-dynode electron multiplier). In some implementations, the ions directly impinge the surface of the electron multiplying element, and consequently no ion-electron converting element is required (such as in the case of a microchannel plate).

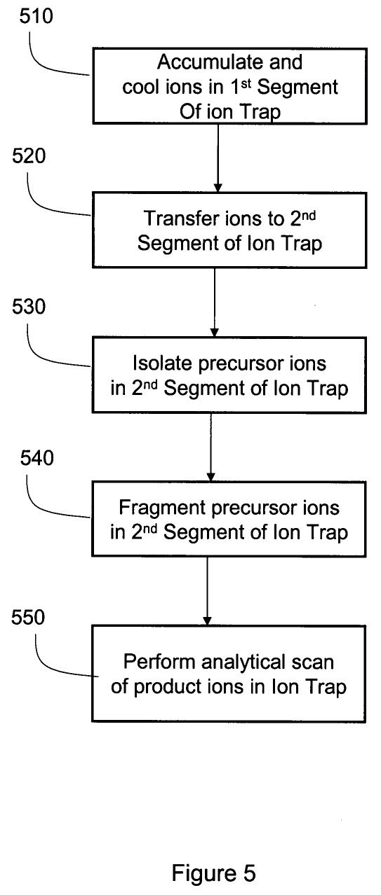

A method for operating an ion trap according to one aspect of the current invention is illustrated in FIG. 5 by a series of steps.

A method of operating segmented ion trap mass analyzer 400 for mass analysis of an analyte substance can be described utilizing the methodology described with reference to FIG. 3. It should be recognized that this method is presented as an example of how a mass analyzer of the present invention may be advantageously employed, and should not be construed as limiting the invention to a particular mode of operation. Referring initially to step 310 of FIG. 3, a DC voltage is applied to at least a portion of the second segment 220 to prevent entry of ions into the second segment 220 of the ion trap 210 and ions produced by ion source 205 (comprised of 110, 115 and 125) and accumulated in the interior volume of the first segment 215 of the ion trap 210. After a sufficient population of ions has been accumulated within the first segment 215 (noting that the duration of the accumulation period may be determined by an appropriate automatic gain control technique), the trapped ions are retained within the first segment 215 of the ion trap 210 for a period sufficient to effect cooling of ions via collisions with the buffer gas, which will typically be on the order of 1-5 milliseconds.

Following the accumulation and cooling step, the cooled ions are transferred into the interior volume of the second segment 220, step 320. Transfer of ions between the two segments is performed by changing the DC voltage applied to the first section 435 of the second segment 220 to remove the potential barrier between the segments of the ion trap 210 and create a potential well within the ion trap 210. Ions then flow from the interior of the first segment 215 of the ion trap 210 to the interior of second segment 220 of the ion trap 210. It is generally desirable to perform the transfer step in a manner that does not substantially increase the kinetic energy of the ions and/or cause them to undergo energetic collisions leading to fragmentation. In one aspect of the invention, an apertured plate 460 is disposed between the first and second segments 215 and 220 respectively, to influence the ions to transfer efficiently from one segment to the other.

After the ions have been transferred to and are trapped within the second segment 220 of the ion trap, an analytical scan is executed by mass-sequentially ejecting ions to detectors 240 in order to acquire a mass spectrum, step 330. Mass-sequential ejection is conventionally performed in a two-dimensional quadrupole ion trap by applying an oscillatory resonance excitation voltage across the slotted rod electrode pair, and ramping the amplitude of the main RF (trapping) voltage applied to the rod electrodes. The ions come into resonance with the associated excitation field in order of their mass-to-charge ratios. The resonantly excited ions experience a progressive increase in their trajectory amplitudes, which eventually exceeds the inner dimension of second segment of the ion trap and causes the ions to be ejected to detectors 240, which responsively generate a signal representative of the number of ions ejected. This signal is conveyed to the data system for further processing to generate a mass spectrum.

This method is particularly useful when further manipulation of the ions is required such as for example when carrying out tandem mass spectrometry (MS/MS) experiments in which ions need to be fragmented. After trapping a population of ions in the first segment 215 of the ion trap 210, a fraction of the trapped ions, for example ions of a specific m/z value or m/z range of values, can transferred to the second segment 220 of the ion trap 210 where manipulation, for example fragmentation, can be carried out and the ions produced from the manipulation then directed to the detector arrangement 240. The rest of the ions can be stored in the first segment 215 using appropriate AC and DC potentials until subsequently required. This is particularly beneficial when the injection time is long. This saves on time, an expensive commodity in the proteomics industry.

FIG. 5 is a flowchart depicting steps of a method for performing MS/MS analysis using a segmented ion trap mass analyzer. In this particular method, isolation of the precursor ions is performed in the second segment 220 of the ion trap 210. In step 510, ions are accumulated and cooled within the first segment 215 of the ion trap 210 in substantially the same manner discussed above in connection with step 310 of the FIG. 3 flowchart. The cooled ions are then transferred to the second segment 220 of the ion trap 210, step 520, as is described above in connection with step 320. In step 530, precursor ions are isolated in the second segment 220 of the ion trap 210. Precursor ion isolation in the second segment 220 of the ion trap 210 may be accomplished by in a manner known in the art, such as application of a notched broadband signal to rod electrodes, with the frequency notch corresponding to the secular frequencies of the mass-to-charge ratio range of interest. This causes substantially all of the ions having mass-to-charge ratios outside of the range of interest to be kinetically excited and removed from the second segment 220 of the ion trap 210 (either by ejection through gaps between rod electrodes, or by striking electrode surfaces), while the precursor ions are retained within the second segment 220 of the ion trap 210.

Next, in step 540, the precursor ions trapped within the second segment 220 of the ion trap 210 are fragmented by an appropriate dissociation technique to produce product ions. Fragmentation may be accomplished by the prior art CAD technique, whereby an excitation voltage having a frequency matching the secular frequency of the precursor ions is applied to rod electrodes to kinetically excite the precursor ions and causing them to undergo energetic collisions with the buffer gas. Other suitable dissociation techniques, including photodissociation, electron capture dissociation (ECD) and electron transfer dissociation (ETD) may be used to fragment ions in step 540. The product ions may be cooled for a predetermined period of time in the first segment 215 of the ion trap 210 to reduce kinetic energy and focus them to the trap centerline. It is noted that steps 530 and 540 may be repeated one or more times to perform multiple stages of isolation and fragmentation to perform MS” analyses, e.g., a product ion of interest may be further isolated in the first segment 215 of the ion trap 210 and fragmented to enable MS³ analysis.

In step 550, the second segment 220 of the ion trap 210 executes an analytical scan of the product ions, as described above in connection with step 330, to generate a mass spectrum of the product ions.

One way to improve the reproducibility of results, the mass resolution and accuracy in ion storage type devices is to control the ion population that is stored/trapped or otherwise confined, and subsequently analyzed in the ion trap. In the art, such methodologies are referred to as Automatic Gain Control (AGC). Implementation of AGC on Matrix Assisted Laser Desorption Ionization (MALDI) systems may be particularly challenging due to the requirement of providing good correlation between the population of ions generated in test shots and those produced for analytical scan. Sample consumption, shot-to-shot laser power variation, and sample morphology, for example, make estimation of the number of laser shots required to produce the desired numbers of ions for the analytical experiment based on the results of test shots very unreliable.

One manner in which the prior art methods address this issue is to generally require a rapid prescan be performed to estimate the ion population trapped in an ion storage type analyzer by utilizing predetermined ionization parameters. Subsequently an analytical scan is performed using optimized ionization parameters that have been derived from the prescan results. These methods typically rely on the ion source being substantially uniform in ion production or generation, relying on, for example, the length of time that an ion source is activated or that an ion trap is gated, to provide a constant ion population. However such methods can be utilized to further improve the results attained by utilization of the methods and apparati of the present invention.

In another aspect of this invention, the ions may be dispersed according to their m/z ratio after entering the ion trap 210 and prior to undergoing analysis in the second segment 220 of the ion trap 210. Dispersion can be accomplished by actuating the segments within the linear ion trap 210. There are several ways in which this may be achieved, one of which is by applying an axial excitation AC voltage that varies axially to the ion trap 210. This essentially enables ions to travel along the trap until they reach a segment where no excitation is applied that affects the range of m/z accommodated by the segment, there they lose energy in collisions and stay in this segment.

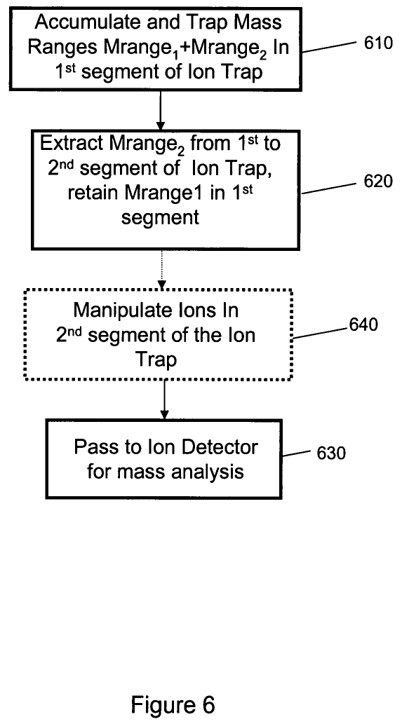

A method for operating an ion trap to achieve such m/z control according to this aspect of the current invention is illustrated in FIG. 6 by a series of steps. In step 610, ions are accumulated and cooled within the first segment 215 of the ion trap 210 in substantially the same manner discussed above in connection with step 310 of the FIG. 3 flowchart. In this example, let us assume that the initial ion population comprises an ion population comprises the mass ranges M_{range1}+M_{range2}. The first segment 215 captures incoming ions and, at the same time excites ions within the second mass range M_{range2} (say 150-2000 Th for example) to overcome the potential barrier separating the first and the second segments 215, 220, (step 620). The potential barrier can be formed by a combination of DC, and optionally, RF fields. The excitation can be provided by an AC field added to the potential barrier so that resonant axial oscillations of ions above a particular mass to charge ratio are excited. The excitation voltage applied has to have an amplitude large enough to excite ions that have mass to charge ratios that are within or above the desired mass range M_{range2} forwards and axially along the ion trap 210, so ions in the mass range M_{range2} propagate forwards. Ions which are ions below the desired mass range, ions with the range M_{range1} are trapped in the first segment 215 and do not propagate further than the first segment 215 of the ion trap 210. Ions corresponding to the first mass range M_{range1} (say 10-150 Th for example) in the first segment 215 will not have acquired sufficient energy to overcome the potential barrier separating segments 215 and 220 and reach the second segment 220 and will be retained in the first segment 215.

A small positive DC voltage can be applied along the length of the second segment 220 of the ion trap 210 in the axial direction dragging ions mass-independently. Subsequently, passing the ions within mass range M_{range2} onto a detector arrangement 230, the detector arrangement 230 providing a signal indicative of the sample portion of the ion population (step 630). Optionally, as indicated by step 640, the sample portion of the ion population in the second segment 220 of the ion trap 210 may be manipulated if so desired, before they are extracted and passed to the detector arrangement 230.

So far, the embodiments specifically described herein have been limited to configurations in which there are two trapping regions or segments. However, the inclusion of additional segments either before and/or after the analysis segment 220 of the ion trap may enable additional functionality to be attained.

For example, a first segment 215 that comprises more than one trapping regions or segments would facilitate, for example, the initial ion population to be spatially partitioned to create several ion populations by m/z range. This configuration may therefore comprise a third segment disposed between the first and the second segments. Aspects of this embodiment are described in greater detail in U.S. patent application Ser. No. 11/485,055 that is incorporated by reference in its entireity.

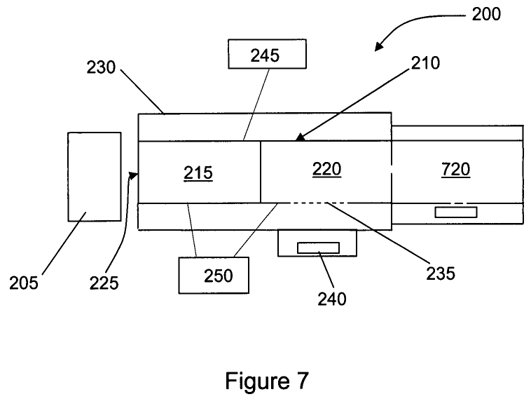

In another example, a third trapping region or segment can be disposed adjacent the second segment 220, in this particular illustrated example shown in FIG. 7, the third segment 720 is disposed after the second segment 220. This configuration enables isolation to be carried out utilizing the first and second segments 215 and 220 respectively, and fragmentation to be carried out in the subsequent third segment 720. In this particular example segment 720 is at a pressure higher than that at which the second segment 220 is held, though alternative configurations are also possible. This configuration also facilitates fragmentation to multiple levels to occur, by utilizing both segments 220 and 720.

In an alternative configuration to that illustrated in FIG. 7, the third trapping region or segment 720 may be located in the same vacuum chamber 230 of the mass spectrometer 200, with ions exiting the second segment 220 of the linear ion trap 210 through an aperture to the third trapping region or segment 720. In yet another alternative configuration, the third trapping region or segment may comprise an ion trap maintained at a different pressure to that of the second segment 220. In this particular configuration, ions can be isolated utilizing the first and second segments 215 and 220 respectively, activated or fragmented in the third trapping region or segment 720, before returning though the aperture to the second segment 220 for final mass spectral analysis. Some of the advantages provided by such a dual ion trap configuration is described in co-pending application Ser. No. 11/639,273.

The foregoing descriptions of ion trap mass analyzers assumes that the second segment 220 of the ion trap 210 is provided with two sets of detector arrangements 230, and that ions are mass-sequentially ejected to the detectors during the analytical scan for acquisition of a mass spectrum. In alternative embodiments, only one detector may be provided. In another alternative embodiment, some or all of the ejected ions may be directed to a downstream mass analyzer (which may take the form, for example, of an electrostatic mass analyzer, a Fourier Transform/Ion Cyclotron Resonance (FTICR) analyzer, or a time-of-flight (TOF) mass analyzer), in which the mass spectrum of the ejected ions is acquired by conventional means.

The methods of the invention can be implemented in digital electronic circuitry, or in hardware, firmware, software, or in combinations of them. Method steps on the invention can be performed by one or more programmable processors executing a computer program to perform functions of the invention by operating on input data and generating output.

Unless otherwise defined, all technical and scientific terms used herein have the meaning commonly understood by one of ordinary skill in the art to which this invention belongs. The disclosed materials, methods, and examples are illustrative only and not intended to be limiting. Skilled artisans will appreciate that methods and materials similar to equivalent to those described herein can be used to practice the invention.

It is to be understood that while the invention has been described in conjunction with the detailed description thereof, the foregoing description is intended to illustrate and not limit the scope of the invention, which is defined by the scope of the appended claims. The various features explained on the basis of the various aspects can be combined to form further aspects of the invention, and other aspects, advantages, and modifications are within the scope of the following claims.

What is claimed is:

1. A mass spectrometer system, comprising:
a laser-based ionization source for generating ions having a wide range of kinetic energies;
the ion trap having at least first and second segments, the first segment of the ion trap having an entrance downstream to the laser-based ionization source such that ions generated by the laser-based ionization source are introduced directly into the entrance of the ion trap, the second segment in communication with the first segment and having an aperture; and
the aperture configured to allow ions to be ejected to a detector to produce a mass spectrum.

2. The mass spectrometer system according to claim 1, wherein the laser-based ionization source comprises a non-continuous ion source selected from the group of a Matrix Assisted Laser Desorption Ionization (MALDI) source, a Laser Desorption Ionization (LDI source), a Laser Desorption/Ionization on Silicon (DIOS) source, or a Surface Enhanced Laser Desorption Ionization (SELDI) source.

3. The mass spectrometer system according to claim 1, wherein the laser-based ionization source comprises a continuous ion source selected from the group of an electrospray-assisted MALDI source, or a MALDI-assisted electrospray source.

4. The mass spectrometer system according to claim 1, wherein the first segment of the ion trap serves to cool the ions, and the second segment of the ion trap provides for mass analysis.

5. The mass spectrometer system according to claim 1, wherein the ion trap is disposed in a vacuum chamber, and the vacuum chamber is configured to receive a sample plate that supports at least one sample.

6. The mass spectrometer system according to claim 5, further comprising an ion optic element disposed between the sample plate and the ion trap to control the transfer of ions into the first segment of the ion trap.

7. The mass spectrometer system according to claim 5, where the laser for ionizing the samples on the sample plate fires through a window disposed in walls of the chamber.

8. The mass spectrometer system according to claim 1, wherein the first and second segments are arranged to have a common coaxial axis, the common axis defining an ion path through the first segment and into the second segment.

9. The mass spectrometer system according to claim 1, wherein the first and second segments are maintained at substantially the same pressure level.

10. The mass spectrometer system according to claim 9, wherein the pressure level is maintained with a gas pressure of less than 50 mtorr.

11. The mass spectrometer system according to claim 9, wherein the pressure level is maintained with a gas pressure of approximately 1mtorr.

12. The mass spectrometer according to claim 1, wherein the ion trap is a segmented two-dimensional ion trap.

13. The mass spectrometer according to claim 12, wherein the second segment comprises at least three sections.

14. The mass spectrometer according to claim 1, further comprising at least one ion optic element disposed between the first internal ion volume and the second internal ion volume, configured to control the transfer of ions therebetween.

15. The mass spectrometer of claim 1, wherein the first segment is configured to receive, confine, and cool ions.

16. The mass spectrometer of claim 1, wherein the detector is a second mass analyzer.

17. The mass spectrometer of claim 1, wherein the second segment of the ion trap is configured to isolate ions for fragmentation.

18. The mass spectrometer of claim 1, wherein the ion trap can be operated to provide Automatic Gain Control.

19. The mass spectrometer of claim 1, wherein the ion trap can be operated to provide mass-to-charge ratio separation prior to ejecting ions to the detector.

20. The mass spectrometer of claim 1, wherein a third segment is disposed between the first and the second segments.

21. The mass spectrometer of claim 1, wherein a third segment is disposed adjacent the second segment.

22. The mass spectrometer of claim 21, wherein the third segment is maintained at a different pressure to that of the second segment.

23. A method of mass spectrometry comprising:
enabling a laser beam to impinge the surface of a sample plate and ionize the sample on the sample plate;
ionizing the sample such that the ions directly enter a first segment of a ion trap disposed in a chamber of the mass spectrometer; and
enabling ions to pass to a second segment of the ion trap for mass analysis.

24. A method of mass spectrometry comprising:
accumulating ions with a a wide range of kinetic energies in a first segment of an ion trap;
transferring the accumulated ions to a second segment of an ion trap;
isolating precursor ions having a first range of mass to charge ratios in the second segment of the ion trap;
fragmenting the precursor ions so as to form product ions; and
ejecting the product ions out of the second segment and to a detector.

25. The method of claim 21, wherein the product ions are ejected radially out of the second segment.

26. The method of claim 21, wherein the ions are cooled in the first segment prior to transferring them to the second segment.
